(19) United States
(12) Patent Application Publication
(10) Pub. No.: US 2014/0294275 A1
(43) Pub. Date: Oct. 2, 2014

(54) METHOD FOR PRODUCING OPTIMISED TOMOGRAPHY IMAGES

(71) Applicant: PIRAMAL IMAGING SA, Matran (CH)

(72) Inventors: Frank-Detlef Scholle, Velten (DE); Joachim Hutter, Wulfrath (DE)

(73) Assignee: PIRAMAL IMAGING SA, Matran (CH)

(21) Appl. No.: 14/353,898

(22) PCT Filed: Oct. 24, 2012
(86) PCT No.: PCT/EP2012/071035

§ 371 Date: Apr. 24, 2014

(30) Foreign Application Priority Data
Oct. 25, 2011 (DE) 10 2011 085 180.1

(51) Int. Cl. G06T 11/00; G06T 5/50

(52) U.S. Cl. CPC G06T 11/008; G06T 5/50; G06T 2207/10072; G06T 2207/30004
USPC 382/131

(57) ABSTRACT

The present invention relates to the technical field of imaging methods, in particular for diagnostic purposes. The subject matter of the present invention is a method for producing optimized tomography images, a computer program product for performing the method according to the invention on a computer, and the optimised images produced by means of the method according to the invention.

The present invention relates to the technical area of imaging methods, in particular for diagnostic purposes. The subject matter of the present invention is a method for producing optimized tomography images, a computer program product for performing the method in accordance with the invention on a computer and the optimized images produced by the method in accordance with the invention.

In today's medicine various imaging methods are used for making visible anatomic and functional structures in living humans or animals and to evaluate in this manner the state of their health.

In contrast to the projection methods such as, for example, the customary x-ray image, in which structures that are successively in the beam path of the x-rays are superposed in the image, tomographic methods permit the production of sectional images and three-dimensional representations (3-D images). A sectional image reproduces the inner structures of the examined body as they would be present after having cut a thin layer out. A 3-D representation shows how the examined structures are spatially present.

In computer tomography (CT), for example, x-ray absorption profiles of the body to be examined are produced from many directions. Then, the degree of absorption can be calculated for each volume element of the body from these absorption profiles and sectional images and 3-D representations can be constructed.

Whereas the morphologicalanatomic structure of a body can be represented by computer tomography, optionally using contrast agents, for example, positron emission tomography (PET) allows the representation of biochemical functionalities of an organism. In PET a radioactively marked tracer is applied into the body of a patient to this end. The tracer bonds selectively to certain biomolecules and the activity of the biomolecules in the body can be rendered visible by imaging the radiation emitted by the tracer.

After the administration of a tracer it takes a while until the tracer has achieved a desired distribution in the body. The tracer is usually administered intravenously and therefore reaches the desired target via the blood path. Part of the administered tracer molecules bonds specifically to the desired target areas and another part is non-specifically distributed. In order to obtain tomography images with a high signal-to-noise ratio it is often appropriate to wait with the images after the administration until a large part of the non-specifically bonding or distributed tracer molecules have left the body region to be examined again since the non-specifically bonding tracer molecules contribute to the background signal in the PET images.

There is a time window after the administration of the tracer before its being transported out of the body region under consideration or before its metabolic breakdown in which an optimal signal-to-noise ratio can be achieved as a function of the tracer used and the physiological parameters of the patient examined.

The imaging of PET scans requires a certain amount of time because positron emission tomography is based on the detection of a plurality of annihilation events. The more events imaged, the higher the number of data used for the reconstruction and the higher the signal-to-noise ratio. The number of events can be influenced in principle by the amount of the tracer administered as well as by the duration of the scan.

However, the loading of the body with radioactive substances should be kept as low as possible in order to avoid side effects. In order to minimize side effects the amount of the tracer administered should therefore be kept as small as possible.

Boundaries are also set for the expansion of the scan time. On the one hand, the examined body region should not move during the imaging since movements in the imagings lead to a false representation of the distribution of the tracer. However, remaining still constitutes a strain for the patient. Some movements such as, for example, breathing movements and movements of the cardiac muscle cannot be avoided during measurements in living organisms. On the other hand, factors such as the half-life of the radioactive isotopes of the tracers and/or of the breakdown of the tracer in the body limit its ability to be detected in time and/or its expression.

Many different factors play a part in the development of a new tracer. The goal of the development is to make a tracer available that supplies specific biochemical information about the body examined with a high signal-to-noise ratio and with a low loading of the body. Every increase of the signal-to-noise ratio created by improvements in the measuring and imaging technology would be a valuable contribution that can have the result of minimizing the loading of the body with a tracer.

The above considerations also apply in a similar manner to other tomography methods, in particular to such methods in which auxiliary agents are administered for the production of signals or the reinforcement of signals such as, for example, tracers, contrast agents or fluorescent dyes to the body to be examined.

It would be desirable to be able to produce tomography imagings with a high signal-to-noise ratio, whereby the loading of the examined patient is to be minimized as regards the radiation dose that the body is exposed to and/or as regards the amount of applied auxiliary agent as well as the duration of the examination.

The previous considerations referred mainly to the production of static instantaneous images of anatomic and/or functional structures.

However, they also apply to a particular extent to the pursuit in time of events in a body, whereby body here comprises the body of a person or of an animal as well as a lifeless object such as, for example, a measuring phantom or a specimen of material. In the production of images that represent the dynamic behavior of an applied auxiliary agent in a body region measurements are carried out on the body range under consideration over a rather long time period. Valuable information for the course of physiological processes in time can be gained from this.

The measured data is subsequently divided into several time ranges, the signal intensities in each volume element determined for the individual time ranges and a signal intensity time curve prepared.

The problem occurs here that the division of the entire measured time into increasingly shorter sections does result in an increasingly higher resolution in time but the shortening of the time ranges has as a consequence a signal with stronger noise. Therefore, either a high spatial resolution with low noise with low or lacking information about time is obtained or a high resolution in time with low spatial resolution.

It would therefore be desirable to be able to compensate at least partially the loss of spatial resolution capacity conditioned by the elevation of the resolution in time.

The cited problems are solved in accordance with the invention by the linking of the spatial measured data with associated time information taking physiological boundary conditions into consideration.

A first subject matter of the present invention is a method for producing optimized tomography images at least comprising the steps:
a) Making a data record are available that represents a region in the body of a patient during a measured time, whereby the representation of the body region in the data record is divided into a plurality of discrete partial regions, whereby the measured time in the data record is divided into a plurality of discrete measured intervals, whereby a discrete structural value is associated with each partial region at each measured interval;
b) Setting up boundary conditions about the course in time of a structural magnitude to be expected in the region of the body during the measuring time;
c) Calculating optimized structural values for each individual partial region on the basis of structural values of the individual partial region at measuring intervals following each other in time, taking the boundary conditions into consideration;
d) Outputting of an optimized data record that represents a region in the body at any selectable points in time during the measured time and that is based on the optimized structural values.

The term tomography image denotes a data record that represents a region in a body during a time span. The concept tomography image should not be limited to sectional images but should also comprise data records that represent a body region in three dimensions. The representation of the body region takes place on the basis of a structural magnitude and of corresponding structural values that are described in detail further below.

The method in accordance with the invention comprises at least the following steps:
a) Making a data record are available that represents a region in the body of a patient during a measured time, whereby the representation of the body region in the data record is divided into a plurality of discrete partial regions, whereby the measured time in the data record is divided into a plurality of discrete measured intervals, whereby a discrete structural value is associated with each partial region at each measured interval;
b) Setting up boundary conditions about the course in time of a structural magnitude to be expected in the region of the body during the measuring time;
c) Calculating optimized structural values for each individual partial region on the basis of structural values of the individual partial region at measuring intervals following each other in time taking the boundary conditions into consideration;
d) Outputting of an optimized data record that represents a region in the body at any selectable points in time during the measured time and that is based on the optimized structural values.

The method in accordance with the invention produces from a first data record, that represents a region in a body during a measured time, a second, optimized data record that represents a region in the body during freely selectable points in time within the measured time.

The second, optimized data record is characterized by the following points:
the noise component is reduced in comparison to the first data record,
image diffusiveness such as is unavoidable in scans that take longer in time is reduced, and the spatial resolution is closer to the physical resolution of the scanning device,
shifts, compressions, expansions, rotations, etc., that can be contained in the first data record during the measured time are as a rule reduced,
representations of the body region at freely selectable points in time within the measured time can be produced,
morphological and/or physiological functions can be emphasized or suppressed in a purposeful manner.

The first data record results from measurements that were carried out on a human or animal body or some other body. The measurements are preferably carried out on a living organism.

The first data record is, for example, a sequence of PET reconstructions, of CT images, of magnetic resonance tomography images (MRT images) or comparable images. Each individual image was produced within a measured interval. The sequence shows the images in successive time sections or measured intervals. The concepts “sequence” and “succession in time” are used synonymously here.

All measured intervals taken together yield the measured time.

The first and the second data record can be a three-dimensional representation. However, they can also be a two-dimensional representation, therefore, a sectional image. Regardless of whether a two-dimensional or three-dimensional representation is concerned, in the following the representation of a spatial region is also discussed.

The representation of the spatial region in the data record is quantized, that is, the spatial region is divided into a discrete number of partial regions (area elements or volume elements), whereby each individual partial region is characterized by its coordinates in space. The coordinates in space should ideally not change during the measured time. They do not change then if the region of the body was not moved relative to the measuring device during the imaging of the measured values for producing the first data record during the measured time. At first, it is assumed for the sake of simplicity that during the measured time neither a movement of the region not movements within the region of the body took place, so that the coordinates of the individual partial regions are constant during the measured time.

A structural value is associated with the individual partial regions at each measured interval. The structural values characterize the state of the partial region in the measured interval considered. The state of each partial region is determined by a series of magnitudes. At least one magnitude that is designated here as a structural magnitude is considered in the method of the invention. It is also conceivable to consider several magnitudes. Structural magnitudes can be, for example, magnitudes such as x-ray absorption (CT), number of decay events per time (PET), MR relaxation times, etc.

In order to clarify the above definitions in more detail, computer tomography and positron emission tomography are cited by way of examples. Computer tomographic images are spatial data records built up from a discrete number of volume elements, whereby each individual volume element is characterized by its coordinates in space and by an absorption value. Usually, the absorption value constitutes a grey state, whereby, for example, “black” represents the lowest degree of absorption (grey stage 0) and “white” the highest degree of absorption (e.g., at 100 grey stages the grey stage 99). As a consequence, the spatial data records can be represented as images. The structural magnitude considered in the case of CT is the degree of absorption of the tissue for x-ray radiation.

In the case of PET the decays of the radionucleotides used is detected over the measured time. The spatial data records can then be reconstructed for any time intervals dividing the entire measured time. Each individual volume element is characterized here by its coordinates in space and a decay rate.

The method of the invention requires several spatial data records that represent the state of the body region examined in an interval of time from each other. The interval of time from each other can be uniform or variable; it is important that the interval of time from each other and the duration of the time for the individual data records are known. Furthermore, the intervals of time and the durations of time are to be selected either during the measuring or, as in the case of PET, during the reconstruction in such a manner that the changes in time of the structural value under consideration that are of interest are resolved in time. The intervals in time and the durations in time should therefore be smaller than the changes in time of the structural value that are considered.

Step a) of the method of the invention represents the making available of a first data record. Since this data record results from measurements, i.e., was generated empirically, it has a noise component.

In particular, PET images have a significant noise component on account of the statistics of the decay events that is all the higher the shorter the time section is, during which annihilation events are registered in order to generate a PET image.

The reduction of the noise component succeeds according to the invention by linking the spatial measured data with the associated information in time, taking into consideration physiological boundary conditions.

These boundary conditions are stated in step b) of the method of the invention. Step b) can take place in time before or after step a), i.e., the designation of the steps with a) and b) does not necessarily mean that step a) takes place first and then step b).

The boundary conditions set the laws for the course in time of the structural magnitude in the region of the body. The course in time of the structural magnitude is not random but necessarily follows the laws fixed, for example, by the anatomy, morphology and/or physiology of the body region and during the use of a tracer or contrast agent by the physical and chemical qualities of the tracer or contrast agent. Thus, for example, it is extremely unlikely that the degree of absorption in the computer tomography of a patent as structural magnitude increases and decreases in an oscillatory manner after a single application of a constrast agent.

If a tracer or contrast agent is administered, it will enter into the body region under consideration and leave it again after a dwell time. If recirculation peaks are disregarded, the pursuance of the tracer or of the contrast agent with measuring technology should therefore show a signal rise with a subsequent signal drop (main maximum). In addition, at the most another signal rise with a subsequent signal drop can occur based on, e.g., extravasation, leakage in tumors, specific or non-specific enrichment (secondary maximum), whereby the secondary maximum is located after the main maximum in time.

Accordingly the boundary conditions are set in which limits a structural value can move and which changes in time of the structural value can be combined with natural laws.

Boundary conditions can be, for example,:
Time constant of the tracer or of the contrast agent in the considered species for the dilution in the blood volume after application
Time constant of the tracer or of the contrast agent in the considered species for the elimination from the blood
Typical courses in time for the concentration of a tracer or of contrast agent. For example, after the application of the tracer or of the contrast agent that is only one signal rise in vivo with a subsequent drop in the vessel component and in addition at the most one rise and one drop on account of, e.g., extravasation (when tracers or contrast agents are small enough to penetrate vessel walls), leakage in tumors, specific or non-specific enrichment, etc.
These courses in time can also be described by a pharmacokinetic model function.

In step c) of the method in accordance with the invention optimized structural values are calculated for each individual partial region. Step c) requires the presence of a first data record and of boundary conditions so that step c) can take place in time only after the steps a) and b). The calculation takes place on the basis of the measured structural values and under consideration of the boundary conditions. For the calculation of the optimized structural values measured structural values are put in relation with each other at measured intervals that succeed each other in time.

The calculation can be carried out in various ways. Two preferred embodiments are described in detail in the following.

### 1. Section-by-Section Smoothing

In a first preferred embodiment of the method in accordance with the invention the following mathematical operations are carried out for each individual partial region:
c1) Division of the measured time into a plurality of sections, whereby the individual sections are shorter, the larger the change of the structural values is in a region of the measured time. The sections must contain at least one measured interval. This is to be considered when measuring the data record in, e.g., computer tomography or magnet resonance tomography.
c2) Averaging the structural values in each section in as far as more than one measured time region is located in the selected time section. Alternatively, instead of the averaging in a section a corresponding data record with the length in time of the considered section can also be reconstructed, such as, for example, as is possible in the case of PET.
c3) Fitting a compensation curve into the averaged structural values, whereby the compensation curve supplies optimized structural values.

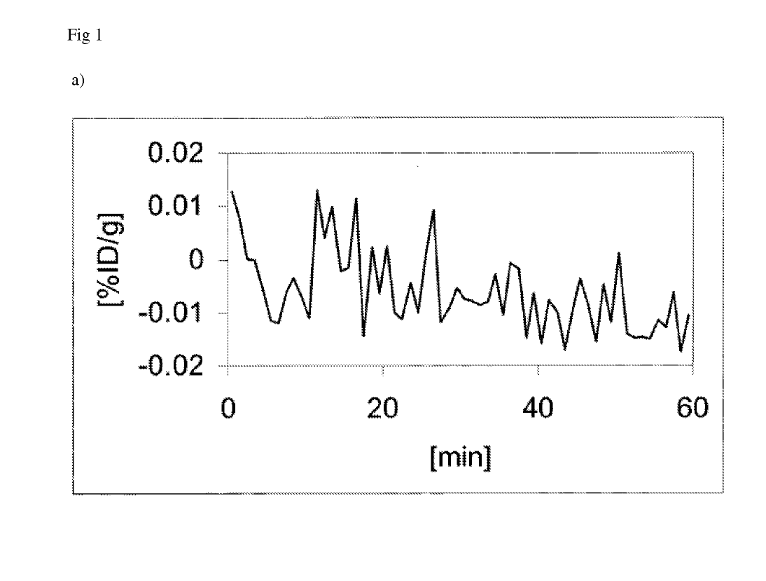

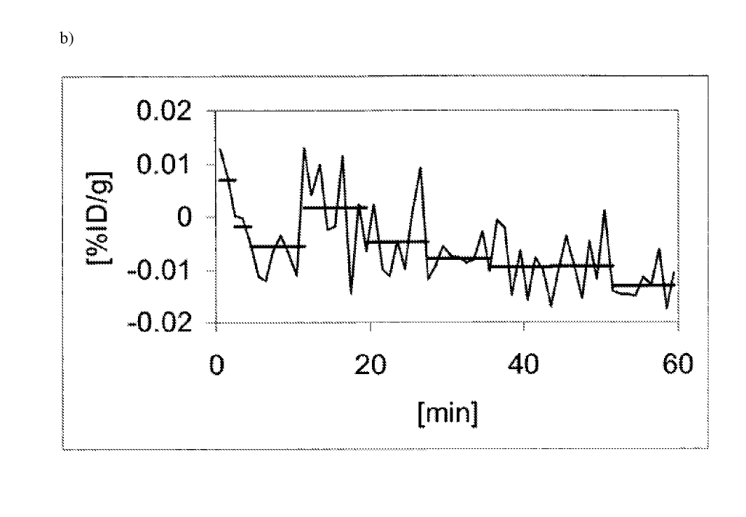

The steps c1) to c3) take place successively in the indicated sequence. In FIG. 1 the calculation is illustrated in a pictorial manner and explained in detail in the example described below.

The magnitude of the sections is adapted to the measured structural values present. In the regions of the measured time in which large changes of the structural value are to be imaged, the sections are shorter than in the regions of the measured time in which the structural values change less strongly from one measured interval to the next measured interval. Accordingly, the first derivation of the structural values according to the time is decisive. The greater it is, the shorter the sections are.

The magnitude of each section is preferably inversely proportional to the amount of the first derivation of the structural values according to the time.

The sections can be selected in such a manner that two sections border one another; it is also conceivable to design the sections in such a manner that two or more sections overlap each other. The sections are preferably designed in such a manner that two sections that are successive in time overlap one another in their boundary regions. In an especially preferred embodiment two sections that are successive in time overlap one another at a boundary point.

As soon as the sections have been determined, an averaging of the structural values located in each section takes place. Averaging is the formation of known mathematical average values such as, for example, the arithmetic or geometric or harmonic or quadratic average value or weighted average. The selection of the particular average value depends in particular on the observed structural magnitude and the existing boundary conditions. Usually, the arithmetic average value is formed.

The average values are preferably associated with the average of the particular time section so that an average value curve results that represents the average structural values as a function of the time. However, it is also conceivable to associated the average values with the first or the last or another point in time of the corresponding time section.

A compensation curve is fitted into the average value curve. The compensation curve is selected on the basis of the boundary conditions that were set up in step b) of the method of the invention. The compensation curve is fit in in such a manner that the deviations between the average value curve and the compensation curve are as small as possible. A weighted adaptation is also conceivable. The term weighting denotes that the compensation curve in the region of the higher-weighted structural values may have a lesser deviation from the average value curve than in the region of the lower-weighted structural values. Suitable average value curves are, for example, spline functions. Depending on boundary conditions, aside from recirculation peaks, for example, a global maximum for the application of a tracer or contrast agent is allowed and, optionally, a local maximum in the case, e.g., of existing extravasation, leakage in tumors, specific or non-specific enrichment in the mathematical function.

Special attention is to be given here to the beginning of the compensation curve. Since rapid changes of high signal values can occur directly after the application of a tracer or contact agent, care is to be taken in the selection of the calculation of the compensation curve that the compensation curve for the points in time before the average first time section appropriately reflect the development of the structural values.

For example, in a simple variant the beginning of the curve can be extrapolated with the aid of the rise of the first two average values.

For the fitting in of the compensation curve a mathematician can use known mathematical optimization methods (see, e.g.,: J. A. Snyman: Practical Mathematical Optimization; Springer Verlag 2005 ; C. Daniel et al.: Fitting equations to data; 2nd ed. Wiley 1980/P. Diereckx: Curve and Surface Fitting with Splines, Oxford Science Publications 1996).

The compensation curve makes available optimized structural values at any points in time within the measured interval since the compensation curve represents a continuous curve in time and does not consist of discrete values.

Therefore, the result is a data record with optimized structural values for freely selectable points in time in the measured interval.

Information is contained in the optimized data record obtained based on the boundary conditions taken into consideration that allow morphological and/or physiological structures within the data record to be purposefully emphasized or suppressed. This possibility is given in the following embodiment in an optimum manner, whereby corresponding operations are also possible in the present embodiment.

### 2. Adaptation to a Mathematical Model

In a second preferred embodiment of the method of the invention a mathematical model is used to calculate the optimized structural values in step c).

This embodiment of the method of the invention comprises the following steps:
c1) Making a mathematical model available that describes the behavior in time of the structural value in the regions of the body;
c2) for every partial region: Adaptation of at least one parameter of the model to the measured structural values and determination of a model function that optimally reproduces the course in time of the measured structural values as the result of a mathematical optimization method, whereby the model function supplies optimized structural values and whereby optimized model parameters can also be obtained by the optimization method.

The mathematical model represents the boundary conditions that were set up in step b) of the method of the invention.

A single- or multi-compartment model is preferably used as mathematical model—depending on the examined body region and the physical-biological-chemical properties of any possibly applied auxiliary agent such as, e.g., a tracer or contrast agent.

Such models are sufficiently known to the person skilled in the art of pharmacokinetics (see, e.g.,

Molecular Imaging: Computer Reconstruction and Practice, Proceedings of the NATO Advanced Study Institute on Molacular Imaging from Physical Principles to Computer Reconstruction and Practice, Springer-Verlag 2006/Physiologically based pharmacokinetic modelling; ed. by M. B. Reddy et al.; Wiley-Interscience 2005/Peter L. Bonate: Pharmacokinetic-Pharmacodynamic Modeling and Siimulation; 2^{nd} ed., Springer-Verlag 2011).

In such models the body region considered is considered as a body built up from one or more compartments. One compartment is used in the model for every change in time of the structural value. Thus, for example, a tracer is distributed after a bolus application in the blood of a patient in a manner and rate characteristic for the patient and the tracer and is gradually eliminated and optionally metabolized.

Another compartment is required, for example, for the model if the tracer has left the vascular system on account of its physiological and chemical properties and can extravasate. A compartment is to be provided in the model function for all effects or physiological functions that lead to a change in time of the structural value in the data record considered.

Various mathematical methods can be used in order to simulate the behavior in time of the structural values with the aid of the model as best as possible.

Thus, a model function can be obtained, for example, by solving the differential equations that can be set up for the model, as is performed for pharmacokinetic modelings.

However, the model function can also be obtained by simulation of the development and time of the structural values considered over the measured time. A mathematical adaption of the model function to the behavior in time of the structural values is possible here by variation of the model function parameters.

The determination of a model function by adaptation to the mathematical model is preferably carried out in the method in accordance with the invention with the simulation approach.

The result is a model function that optimally reproduces the behavior in time of the structural values in a mathematical sense. The model function makes optimized structural values available at any points in time within the measured interval since the model function represents a continuous time curve and does not consist of discrete values.

Furthermore, a data record of optimized parameters results from the cited method variant for each partial region of the scanned body that indicates the influence of each compartment on the course in time of the structural value.

This makes it possible to emphasize, reduce or entirely omit the contributions of the individual compartments.

This can take place in that in the calculation of the data record for any point in time within the measured time not all optimized values of the model parameters determined by the adaptation calculation are used. By limiting the value range of one or more parameters the contribution of one or more compartments can be influenced in a purposeful manner. Thus, for example, in a MR tomography on a patient supported by contrast agent the contrasting of the vascular system can be suppressed or emphasized in the outputted data record as required.

Therefore, the result of the model adaptation is a data record with optimized structural values and a data record with associated model parameters with which the optimized data record can be outputted in different variants useful for the understanding of the examination data.

It was assumed above for the sake of simplicity that the body region did not move relative to the measuring device during the production of the first data state based on measured values. On the other hand, if it did move, then changes in time of the structural values are due not only to changes of the structural or functional state of the body region observed but rather also to the fact that the observed partial regions shifted in the course of time relative to the measuring device. If these changes in time of the structural value are not compatible with the boundary conditions, they are reduced or eliminated by the described method. This applies in particular to structural value changes caused by movements that are more rapid than the observed changes in time of the structural value or which have an oscillatory character such as, for example, the movement of the cardiac muscle.

Since unintended movements of the body during the scanning process can always result in a falsification of the representation of the scanned body, it is basically advantageous to be able to recognize them already in the first data record based on measured values and to reduce or eliminate them. However, if the first data record has too great a spatial noise component, a movement correction can also be carried out on the basis of the optimized data record, i.e., after the carrying out of the method of the invention in as far as the movement had not already been sufficiently reduced by the method of the invention.

The outputting of an optimized data record takes place in step d) of the method of the invention. The optimized data record represents a region in the examined body. The region in step d) usually coincides with the region in step a). However, it is also conceivable that the region in step d) represents only a partial region of the region from step a). It is conceivable that partial regions are distorted in the framework of or following the calculation of the optimized structural values in step c) or by a movement correction. This applies in particular to boundary regions of the data record that possibly do not spatially coincide in all measured time intervals on account of movement.

The optimized data record is based on the optimized structural values from step c). Therefore, step d) can only take place following step c).

The optimized data record can be outputted in the form of one or more two- or three-dimensional representations of the body region on a screen or as a printout. It is also conceivable that the output takes place on a data medium in the form of machine-readable data.

The optimized data record produced by the method in accordance with the invention is also subject matter of the present invention.

Another subject matter of the present invention is a computer program product with program code that can be stored on a machine-readable carrier for carrying out the method of the invention on a computer.

The method in accordance with the invention is suitable for optimizing all known 3-D images or tomography images such as, for example, for optimizing SPECT-, PET-, CT- or MRT images or measured data from a 3-D-or 4-D ultrasonic method or from optical tomography (see pertinent literature such as, e.g.,: Ashok Kharana, Nirvikar Dahiya: 3D & 4D Ultrasound—A Text and Atlas, Jaypee Brothers Medical Publishers (P) Ltd., 2004; R. Weissleder et al.: Molecular Imaging—Principles and Practice, People's Medical Publishing House, USA, 2010, G. B. Saha: Basics of PET Imaging, 2nd edition, Springer 2010; S. A. Jackson, K. M. Thomas.; CT, MRT, Ultraschall auf einen Blick, Elsevier 2009; Olaf Dössel: Bildgebende Verfahren in der Medizin Springer-Verlag Berlin Heidelberg New York, 2000).

As a rule, distinctly noise-reduced tomography images can be surprisingly produced with the aid of the method in accordance with the invention from a sequence of measured tomography images without the kinetics of the measured data being lost such as, for example, in the preparation of the so-called MIP (Maximum Intensity Projection) or the averaging of all individual scans.

Movements that occur during the measuring time in the scanned body or in partial regions of the scanned body are reduced in many instances by the method of the invention, which is advantageous in particular in the case of data records with heavy noise. Image distortions such as are unavoidable in the case of static images with only one data record per total measured time are reduced with the method of the invention and the spatial resolution is closer to the physically possible resolution of the scanning device.

Representations of a body region can be produced as required in which morphological and/or physiological structures are emphasized or suppressed in a purposeful manner. This allows, for example, the preparation of better diagnoses.

The invention is explained in detail in the description of the figures (FIGS. 1 to 4) and using an example, without being limited to them.

### EXAMPLE

The following explanation of the method of the invention is made for the case of section-by-section smoothing.

Assume a course in time of a structural value for a discrete spatial partial region from a tomographic PET data record such as is shown in FIG. 1a.

At the beginning of this course in time a signal drop can be recognized such as is to be expected after application and flooding of the tracer in vivo. Subsequently, the curve apparently also runs through a maximum before it drops at the end of the scanning time to a low value. The noise that is not untypical for PET data is superposed on everything based on the statistics of the decay events.

Such a course would be expected for a thrombus tracer that could have a main maximum in the data curve based on the flooding and washing out of the tracer after application and another maximum based on a possible enrichment of the tracer in or on any thrombi present in the vascular space. Accordingly, the boundary conditions for this case are selected with a main- and a secondary maximum in the structural value time curve.

The lengths of the sections required for the section-by-section smoothing are entered in FIG. 1b. They can be roughly read out of the measured curve. Short sections require a rapid change of the structural value at the beginning of the curve, in contrast to which long sections are to be selected for the secondary maximum extending over a longer time period. In measurements that are not carried out for the first time in the combination of tracer or contrast agent and examined species the possible changes of the structural value and therefore also the sectional lengths are known and can be accordingly selected.

An analogous situation applies to the case of adapting the measured data to a pharmacological model.

Next, the structural values located in the various time sections are averaged per section and corrected in the height of the value in accordance with the selected boundary conditions for a main maximum and maximally a secondary maximum if necessary. In the present structural value curve the somewhat higher average value of the next to the last section (minutes 44-52) are to be corrected down to the average value of the third to the last section (minutes 36-44) for this reason since there may be no other maximum in the curve at less than 20 minutes on account of the boundary conditions except for the clearly larger secondary maximum.

Finally, a compensation curve was mathematically placed through the calculated average value of the sections (see FIG. 1c) and an optimized data record prepared therewith.

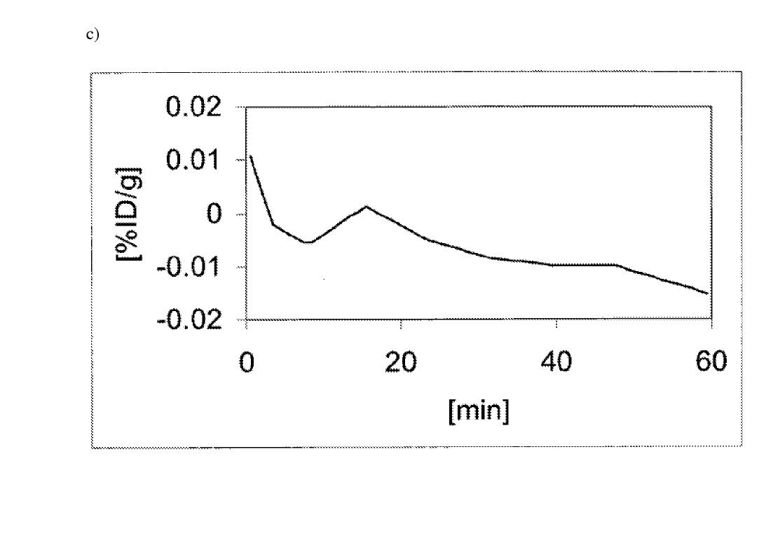

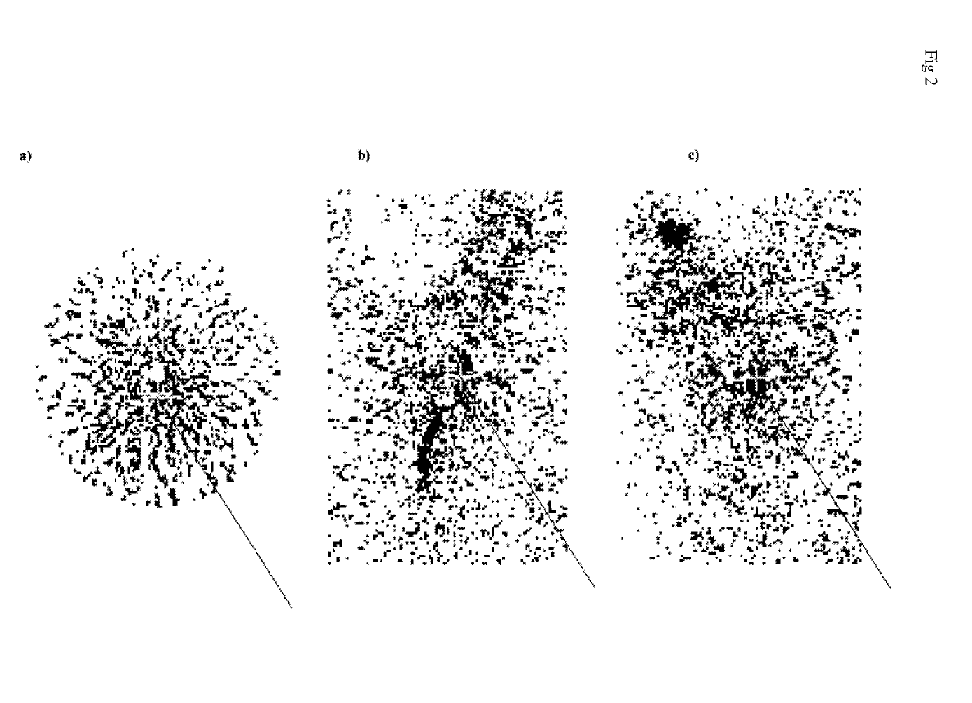

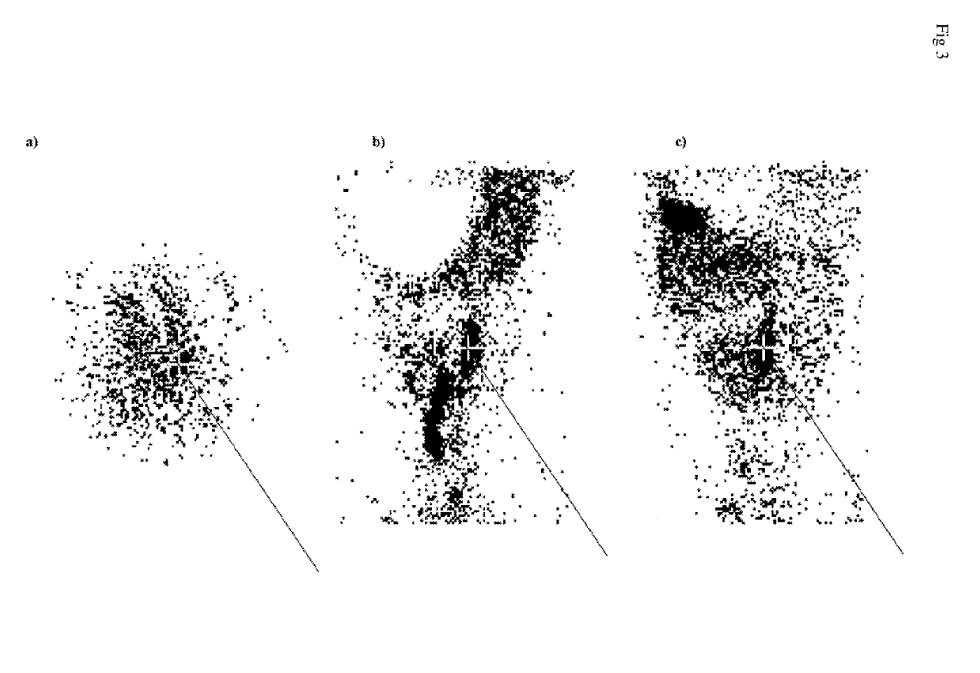

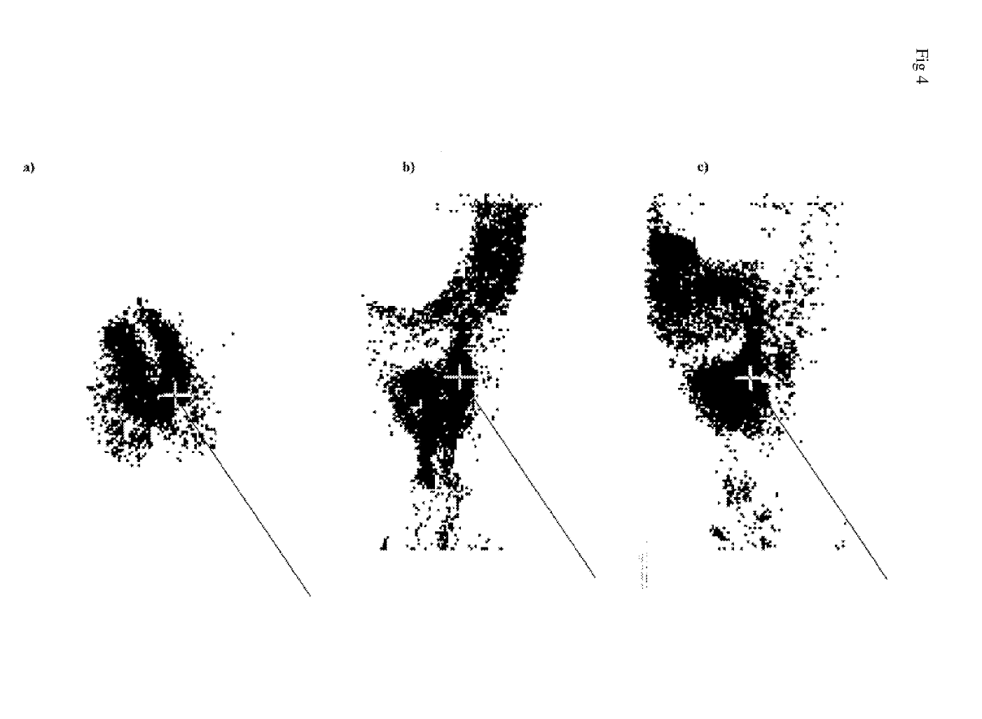

FIGS. 2 to 4 show by way of example a section from a measured data record in the anatomically customary planes. FIG. 2 shows the data record without processing by the method in accordance with the invention. In comparison to it, in FIG. 3 the noise reduction that took place with the method in accordance with the invention is apparent using readily recognizable structures and considerably fewer individual spots. The structure recognizable in FIG. 3 is confirmed in FIG. 4. However, the data record shown in FIG. 4 does not allow any more conclusions about the kinetics of the tracer distribution in the scanned body by the averaging of all measuring time intervals, in contrast to the data record in FIG. 3.

### DESCRIPTION OF THE FIGURES

FIG. 1: Representation of an exemplary course in time of the tracer concentration during an in vivo PET scan in a discrete partial region of a PET data record
a) without noise reduction by the method of the invention,
b) without noise reduction by the method of the invention and with additionally sketched-in, suitable sections for the averaging of sections according to step c2) of the section-by-section smoothing (horizontal beams) and
c) after using the method of the invention.
The section beams in figure lb are entered at the height of the value obtained from the averaging of sections. The start of the PET scan takes place directly after application of the tracer.

FIG. 2: Representation of the anatomical views
(a) transversal,
(b) coronal and
(c) sagittal
from an in vivo 3-D PET scan.
The scan was imaged on an Cynomolgus monkey after application of a thrombus tracer from the PET tracer research with a small-animal PET scanner. The measured data record 28 of 60 successively performed scans is shown without noise reduction by the method of the invention. The measuring time of each measured data record was 1 minute. The measuring of all data records took place successively without a pause. The planes for the represented views are identical to those in FIGS. 3a-c and FIGS. 4a-c. The crosses recognizable in the figures show the cursor position in the computer program product of the invention with which the figures were prepared.

FIG. 3: Representation of the anatomical views
(a) transversal,
(b) coronal and
(c) sagittal
from an in vivo 3-D PET Scan.
The scan was imaged on an Cynomolgus monkey after application of a thrombus tracer from the PET tracer research with a small-animal PET scanner. The measured data record 28 of 60 successively performed scans is shown after application of the method in accordance the invention. The measuring time of each measured data record was 1 minute. The measuring of all data records took place successively without a pause. The planes for the represented views are identical to those in FIGS. 2a-c and FIGS. 4a-c. The crosses recognizable in the figures show the cursor position in the computer program product of the invention with which the figures were prepared.

FIG. 4: Representation of the anatomical views
(a) transversal,
(b) coronal and
(c) sagittal
from an in vivo 3-D PET scan.
The scan was imaged on an Cynomolgus monkey after application of a thrombus tracer from the PET tracer research with a small-animal PET scanner. The averaging of all 60 individual data records scanned during the total measuring time is shown. The measuring time of each measured data record was 1 minute. The measuring of all data records took place successively without a pause. The individual data records were not processed with the method of the invention. The planes for the represented views are identical to those in FIGS. 2a-c and FIGS. 3a-c. The crosses recognizable in the figures show the cursor position in the computer program product of the invention with which the figures were prepared.

1. A method for producing optimized tomography images, comprising at least the steps:
a) Making a data record are available that represents a region in the body of a patient during a measured time, whereby the representation of the body region in the data record is divided into a plurality of discrete partial regions, whereby the measured time in the data record is divided into a plurality of discrete measured intervals, whereby a discrete structural value is associated with each partial region at each measured interval;
b) Setting up boundary conditions about the course in time of a structural magnitude to be expected in the region of the body during the measuring time;
c) Calculating optimized structural values for each individual partial region on the basis of structural values of the individual partial region at measuring intervals following each other in time taking the boundary conditions into consideration;
d) Outputting of an optimized data record that represents a region in the body at any selectable points in time during the measured time and that is based on the optimized structural values.

2. The method according to claim 1, characterized in that the following operations are carried out for each partial region in step c):
c1) Division of the measured time into a plurality of sections, whereby the individual sections are shorter, the larger the change of the structural values is in a region of the measured time;
c2) Averaging the structural values for each partial region in each section;
c3) Fitting a compensation curve into the averaged structural values, whereby the compensation curve supplies optimized structural values.

3. The method according to claim 2, characterized in that the magnitude of each section in step c1) is inversely proportional to the amount of the first derivation of the structural values according to the time.

4. The method according to claim 2, characterized in that the sections in step c1) are shaped in such a manner that each two sections following one another in time overlap in their boundary regions.

5. The method according to claim 1, characterized in that in step c) the following operations are carried out:
c1) Making a mathematical model available that describes the behavior in time of the structural value in the regions of the body;
c2) for every partial region: Adaptation of at least one parameter of the model to the measured structural values and determination of a model function that optimally reproduces the course in time of the measured structural values as the result of a mathematical optimization method, whereby the model function supplies optimized structural values and whereby optimized model parameters can also be obtained by the optimization method.

6. The method according to claim 5, characterized in that the mathematical model is a pharmacokinetic single- or multi-compartment model.

7. The method according to claim 1, characterized in that the first data record results from measurements performed on a living organism.

8. The method according to claim 1, characterized in that the first data record results from measurements performed on a non-living object.

9. The method according to claim 1, characterized in that the first data record is SPECT-, PET-, CT- or MRT images or a measured data record from a 3-D-or 4-D ultrasonic method or from optical tomography.

10. The method according to claim 1, characterized in that in the optimized data record structural values based on the boundary conditions are purposefully changed in order to emphasize or suppress morphological and/or physiological structures.

11. An optimized data record produced by a method in accordance with claim 1.

12. A computer program product with program code for carrying out the method according to claim 1 on a computer system
